(19) United States
(12) Patent Application Publication
(10) Pub. No.: US 2026/0073247 A1
(43) Pub. Date: Mar. 12, 2026

(54) KNOWLEDGE GRAPH CREATION UTILIZING EMBEDDING AND LARGE LANGUAGE MODELS

(71) Applicant: Intuit, Inc., Mountain View, CA (US)

(72) Inventor: Kevin FURBISH, Tampa, FL (US)

(21) Appl. No.: 18/883,803

(22) Filed: Sep. 12, 2024

(51) Int. Cl. G06N 5/022

(52) U.S. Cl. CPC G06N 5/022

(57) ABSTRACT

Certain aspects of the disclosure provide techniques for creating a knowledge graph. A method generally includes for each respective item, of a plurality of items, associated with a respective industry: adding an item node in the knowledge graph for the respective item; adding an industry node in the knowledge graph for the respective industry if no industry node for the respective industry exists in the knowledge graph; generating semantically similar items to the respective item; prompting one or more machine learning models to determine that the respective item and at least one semantically similar item of the set of semantically similar items are associated; and generating an edge between the respective item and the at least one semantically similar item in the knowledge graph based on the association determination.

### BACKGROUND

### Field

Aspects of the present disclosure relate to techniques for creating a knowledge graph.

### Description of Related Art

A knowledge graph, also known as a semantic network, is a graph that represents a network of real-world entities—e.g., objects, events, people, situations, states, or concepts—and encodes the relationships between them. In particular, a knowledge graph is made up of three main components: nodes, edges, and labels. Nodes, also called vertices or points, represent the entities for which relationships are defined. A node may represent a real-world entity or an abstract concept. Edges, also called links, connect two nodes when a relationship exists between them. Labels may be assigned to node(s) and/or edge(s) in the knowledge graph to convey precise information, often referred to as “semantics,” about what the node(s) and/or relationship(s) represent. For example, a knowledge graph created for an online marketplace may have a plurality of interconnected nodes, where each node represents a buyer, a seller, or a product. The edges in the knowledge graph may represent relationships between each of the nodes, including “wants-to-buy,”“has bought,”“is a customer of,”“is selling,”and the like.

Knowledge graphs have applications in multiple industries, including, but not limited to, healthcare, entertainment, retail, and finance. As a first example, knowledge graphs benefit the healthcare industry by organizing and categorizing relationships within medical research. This information helps to assist providers by validating diagnoses and/or identifying treatment plans based on individual needs. As a second example, knowledge graphs are leveraged in the entertainment industry by artificial intelligence (AI)-based recommendation engines to recommend new content (e.g., posts, images, videos, etc.) for users of content platforms, such as movie-streaming platforms or social media, to view and/or watch. For instance, a knowledge graph may be generated for a user of a movie-streaming platform to represent relationships between genres, plots, actors, and more liked and/or disliked by a user. This knowledge graph may be used to recommend movies to the user that fit that user's taste and preferences. As a third example, knowledge graphs may be leveraged in the financial industry to capture expert knowledge on different domains, such as capture expert knowledge on the tax domain.

Recently, knowledge graphs have proven to be a powerful tool for many organizations, transforming their infrastructure for managing data. For example, in the past, organizations may have conventionally maintained thousands of database systems in production, with data describing their customers, employees, suppliers, legal, and more. Due to its heterogeneous nature, this data may have been conventionally stored in unconnected silos, making it difficult to leverage its valuable insights. To address this problem, organizations have since adopted master data management solutions that leverage the power of knowledge graphs to consolidate their systems and create one master view of their data. Knowledge graphs apply semantics to give context and relationships to data, providing a framework for data integration, unification, analytics, and/or sharing for an organization. By fundamentally understanding the way data relates throughout an organization, knowledge graphs offer an added dimension of context which may help to inform everything from research and development to inventory management, employee connection, quality assurance, business propositions, and more.

### SUMMARY

One aspect provides a method of creating a knowledge graph, comprising: for each respective item, of a plurality of items, associated with a respective industry of one or more industries: adding an item node in the knowledge graph for the respective item; adding an industry node in the knowledge graph for the respective industry associated with the respective item if no industry node for the respective industry exists in the knowledge graph; generating a set of semantically similar items to the respective item; prompting one or more machine learning models to determine that the respective item and at least one semantically similar item of the set of semantically similar items are associated; and generating an edge between the respective item and the at least one semantically similar item in the knowledge graph based on the association determination.

Another aspect provides a method of providing one or more recommendations comprising: querying a knowledge graph to generate the one or more recommendations, wherein the knowledge graph comprises: a plurality of item nodes associated with a plurality of items, wherein: each respective item, of the plurality of items, are associated with a respective industry of one or more industries and each respective item associated with the respective industry comprises a unique item-industry pair; one or more industry nodes associated with the one or more industries; and a plurality of edges, wherein: each respective edge of the plurality of edges connects a respective pair of items nodes of the plurality of item nodes, and each respective edge indicating that the respective items associated with the respective pair of item nodes comprise: associated items in a same industry of the one or more industries that are associated, or associated items in different industries of the one or more industries; and providing the one or more recommendations.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system that includes a knowledge graph, created based on the techniques described herein.

FIG. 2 depicts an example workflow for creating a knowledge graph.

FIGS. 3A-3D depict the creation of an example product and service knowledge graph.

FIG. 4 depicts an example method for knowledge graph creation.

FIG. 5 depicts an example method for providing recommendation(s) using a knowledge graph.

FIG. 6 depicts an example processing system with which aspects of the present disclosure can be performed.

FIG. 7 depicts another example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Conventionally, ontologies and semantics have each played a distinct and important role in the creation of a knowledge graph. For example, an ontology is a formally defined representation of knowledge that sets out the concepts and relationships within a particular domain. An ontology typically consists of a set of (1) classes, (2) relationships, and (3) attributes, which may be used to describe and organize information about entities in that domain. Classes are fundamental categories of entities within a domain, such as “Patient,” “Disease,” and “Treatment” in a healthcare ontology. Relationships define how classes are related to each other, for example, in the healthcare ontology, a relationship “has Symptom” may connect a “Patient” class to a “Disease” class. Attributes are aspects, features, and/or characteristics associated with a class, for example, in a healthcare ontology, attributes “gender” and “age” may be associated with a “Patient” class. Thus, an ontology may provide a structured framework, formal definitions, and/or common vocabulary required to organize domain-specific knowledge in a way that creates a shared understanding.

Semantics, the other important part of a knowledge graph, focus on discerning the relationships and connections between specific entities in a given domain. This includes defining relationships and their properties and understanding the entities'meanings and/or different possible interpretations.

This semantic understanding is generally based on one or more ontologies created for the particular domain. For example, using the healthcare ontology described above, different classes and attributes may be assigned to different entities associated with a particular hospital, such as doctors, nurses, support staff, patients, visitors, treatments, surgeries, departments, etc. Based on these classes and attributes, relationships between the different entities may be identified and used to construct a knowledge graph. The constructed knowledge graph may help to centralize the hospital's information in one place, thereby helping to visualize complex relationships present among entities associated with the hospital (e.g., providing a master data management solution for the hospital).

While valuable to generating a knowledge graph, ontology development for a particular domain is a technically challenging task. For example, one challenge of this task relates to the availability of resources. Specifically, ontology development may be resource-intensive, requiring significant time, expertise, and/or funding. Developing and maintaining an ontology may require a dedicated team of experts, as well as continuous access to relevant data and information sources for a domain. Limited resources may constrain the scope and quality of the ontology, as well as limit its usefulness, such as for knowledge graph creation.

Another challenge of ontology development may be attributed to the use of often ambiguous and/or complex language associated with a domain. Ambiguous and/or complex language may make it difficult to identify and define classes and/or relationships for the domain. In particular, a domain language may include vague or abstract terms, and/or may include multiple interpretations for a same concept. For example, in the food and beverage industry (e.g., an example domain), the term “cleaning” (e.g., an example entity in this domain) may occur in many different contexts. In a first context, “cleaning” may refer to the task of removing dirt, marks, and/or mess from an environment, especially by washing, wiping, and/or brushing. In a second context, “cleaning” may refer to the removal of the entrails and/or other inedible parts from poultry, fish, etc.

Further, tacit knowledge may be difficult to capture in an ontology. Tacit knowledge refers to the knowledge, skills, and/or abilities that people gain through experience, intuition, and practice. Tacit knowledge is subjective, personal, and context-dependent, and is deeply rooted in an individual's cognitive and emotional skills. It is often not shared or documented in formal ways, and thus can be challenging to capture and codify in an ontology. For example, capturing tacit knowledge may require a deep understanding of the domain and the context in which the knowledge is used.

Additionally, an ontology may comprise a representation of some evolving knowledge, and thus, may need to change over time. For example, a knowledge graph relying on this underlying knowledge may be compromised and/or yield incorrect results if the underlying knowledge is incorrect and/or outdated. Thus, maintaining an up-to-date ontology per domain may be valuable, and may require the utmost diligence of an ontology expert. Further, one change to an ontology may cause other relationships in the ontology to become invalid, thereby requiring a rework on the ontology, which may be time and resource consuming (as described above).

Embodiments described herein overcome the aforementioned technical problems and improve upon the state of the art by providing a system, combining one or more embedding models with one or more large language models (LLMs), configured to create a knowledge graph. The system obviates the step of developing an ontology for knowledge graph creation by leveraging the combined capabilities of embedding model(s) and LLM(s) to discern different classes and/or relationships that exist among data from a particular domain. As used herein, an embedding model is a model used to perform embedding, which is a process where text is given numerical representation and organized in a vector space (e.g., a low-dimensional space). Further, an LLM is a type of machine learning (ML) model that supports natural language processing (NLP) tasks, such as generating text, analyzing sentiments, answering prompts (e.g., specific instructions and/or requests posed in natural language) in a conversational manner, and/or the like. LLMs represent a transformative force in many industries by assimilating vast amounts of knowledge and strategically deploying it to, in some cases, answer specific questions.

In certain aspects, the embedding model(s) may be used to generate embeddings for entities in a database, associated with a domain, such that a set of semantically similar entities to a first entity in the database of entities may be identified. For example, the embedding model(s) may be used to convert the entities in the dataset into multiple embeddings. The embeddings of other entities in the dataset may be compared against the embedding of the first entity to determine a relatedness and/or similarity of each embedding to the first entity's embedding, such as to identify the set of semantically similar entities to the first entity. This set of semantically similar entities to the first entity may be verified utilizing one or more of the LLM(s). For example, the LLM(s) may be prompted to determine if the first entity and each semantically similar entity in the set are associated, and if so, the type of association between the respective entities. In certain aspects, entities are “associated” when they represent a same entity. In certain aspects, entities are “associated” when one entity is a specie of a genus of the other entity (e.g., a variant of the other). In certain aspects, entities are “associated” when the entities are related, or connected (e.g., such as via a transaction). In certain aspects, the determined association(s) are used to construct a knowledge graph for the database.

In certain aspects, the entities included in a database may include at least two of the same entity associated with at least one differing attribute (e.g., such as an associated industry). The LLM(s) may be used to determine an association between these entities, if any exists. For example, the LLM(s) may be prompted to determine if the entities are associated, and if so, the type of association between the entities. In certain aspects, the entities are “associated” when they represent a same entity (e.g., such as across industries). In certain aspects, the determined association(s) are used to construct a knowledge graph for the database.

In certain aspects, the embedding model(s) and LLM(s) described herein are leveraged, in place of an ontology, to create a product and service knowledge graph for a particular domain. A product and service knowledge graph is a specific form of knowledge graph built on top of a product and/or service database, such as to encode relationships between product(s) and/or service(s) associated with (e.g., offered for sale by) one or more industries. As used herein, a product may refer to a tangible item that can be consumed or possessed (e.g., such as a beverage, a soda, a gift card, etc.), while a service may refer to an intangible action that is usually performed for a recipient (e.g., cleaning, catering, etc.). The embedding model(s) and LLM(s) may be used to identify associations between products and/or services associated with a same industry (e.g., intra-industry associations) and/or different industries (e.g., inter-industry associations), and then use the determined associations to construct the product and service knowledge graph. Although aspects herein are described with respect to the creation of a product and service knowledge graph, in certain other aspects, the techniques for creating a knowledge graph, which utilize embedding model(s) and LLM(s), may be similarly used to generate other types of knowledge graphs, such as for other domains.

The techniques described herein, which leverage the capabilities of embedding model(s) and LLM(s) to create knowledge graphs, thus provide significant technical advantages over conventional solutions, such as the ability carry out the creation of a knowledge graph for a particular domain without requiring prior information about the domain. This technical effect overcomes the technical problems associated with developing an ontology for the domain, including limited resource availability, the inability to capture tacit knowledge, domain-specific ambiguities, and the need to maintain up-to-date information, as described above. For example, the knowledge graph creation techniques described herein need not rely on the underlying knowledge provided via an ontology to discern relationships between entities, like conventional approaches, and thus provide a technical advantage over those conventional approaches.

Notably, the improved knowledge graph creation techniques described herein may further improve the function of any existing application that utilizes a knowledge graph, such as an application configured to provide recommendation(s) based on the knowledge graph. For example, the combined use of the embedding model(s) and the LLM(s) to identify associations between entities of a domain may increase the accuracy of a knowledge graph created for the domain (e.g., the LLM(s) provide a further check on the associations between embeddings created by the embedding model(s)). This improved knowledge graph may further enhance the performance of any application(s) that rely on this knowledge graph for performing various tasks, such as providing one or more recommendations.

### Example System Including a Knowledge Graph

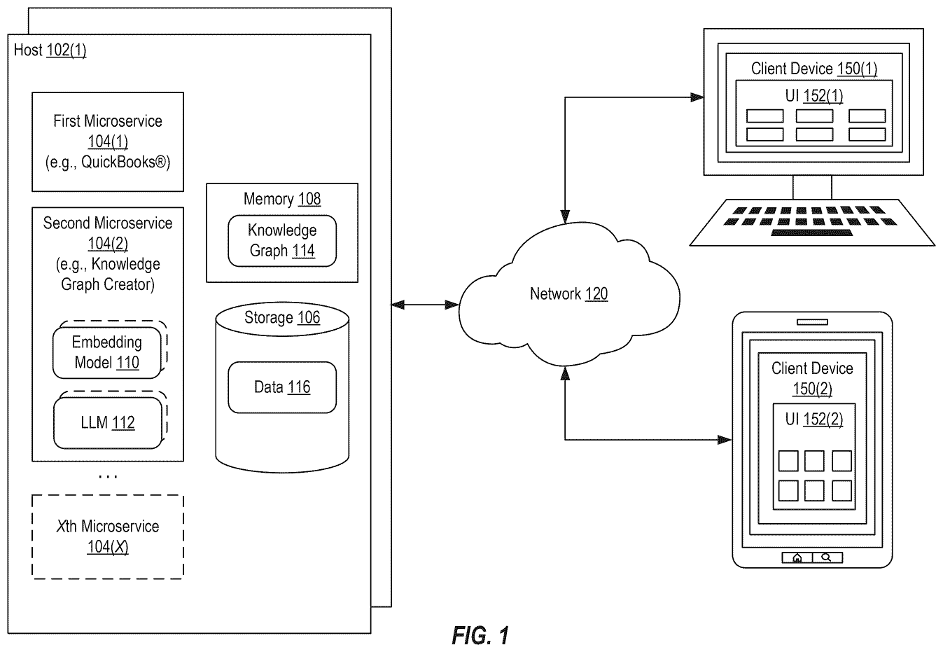

FIG. 1 depicts an example system 100 that includes a knowledge graph 114. In certain aspects, knowledge graph 114 may be created by a knowledge graph creator, implemented as a software-defined service (e.g., in some cases, a cloud-native software-defined service), also referred to herein as “a microservice 104.” Generally, microservices 104 are loosely coupled and independently deployable services (or software) that may make up an application. Microservices 104 may enable segmented, granular level functionalities within a larger system infrastructure.

As shown in FIG. 1, system 100 comprises client devices 150(1)-(2) (collectively referred to herein as “client devices 150”) and host(s) 102 interconnected through a network 120. Network 120 may be, for example, a direct link, a local area network (LAN), a wide area network (WAN), such as the Internet, another type of network, or a combination of one or more of these networks.

Host(s) 102 may be geographically co-located servers on the same rack or on different racks in any arbitrary location in a data center. Host(s) 102 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 106, and other components (e.g., only storage 106 is shown in FIG. 1).

A first host 102(1) in system 100 may host a plurality of microservices 104(1)-(X) (collectively referred to herein as “microservices 104” and individually referred to herein as a “microservice 104”), where X is an integer greater than one. The microservices 104 may be deployed using virtual machines (VMs) and/or container(s) running on first host 102(1) (e.g., where first host 102(1) is running a hypervisor (not shown) used to abstract processor, memory, storage, and networking resources of first host 102(1)'s hardware platform).

Client device 150(1) and client device 150(2) may each include a user interface (UI) 152(1), 152(2), respectively, which may be used to communicate with, at least, a first microservice 104(1), a second microservice 104(2), and/or a third microservice 104(3) using the network 120. For example, communication between client devices 150 and a microservice 104 may be facilitated by one or more application programming interfaces (APIs). Examples of client devices 150 may include a smartphone, a personal computer, a tablet, a laptop computer, and/or other devices.

As shown in FIG. 1, the microservices 104 may include, at least, the first microservice 104(1), the second microservice 104(2), and the third microservice 104(3). In certain aspects, the first microservice 104(1) implements an information service, which is any network 120 accessible service that maintains financial data, medical data, personal identification data, and/or other data types. For example, the information service may include QuickBooks® and its variants made commercially available by Intuit® of Mountain View, California.

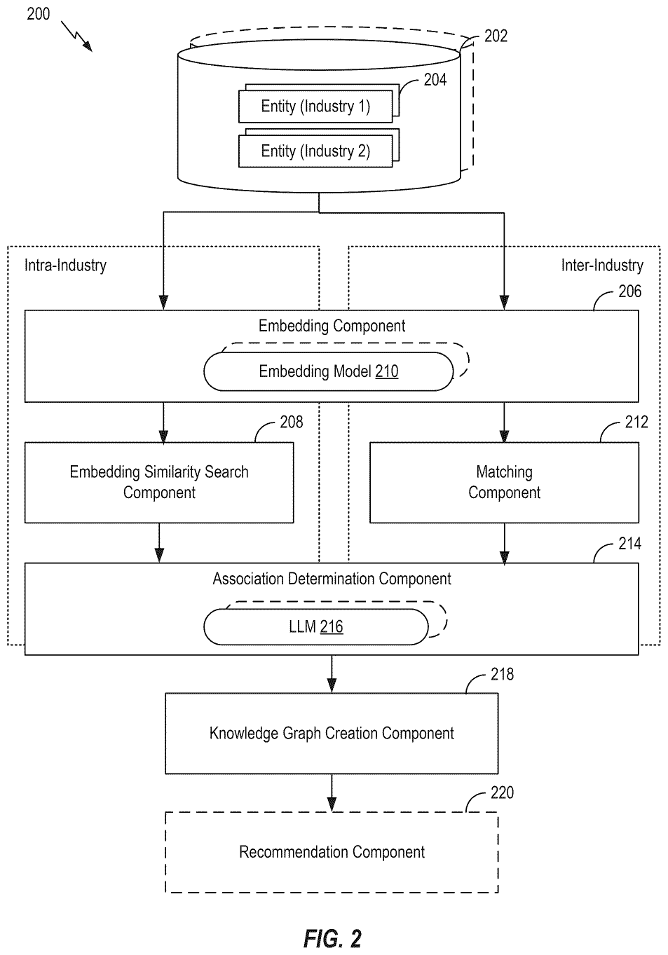

In certain embodiments, the second microservice 104(2) implements a knowledge graph creation service. The knowledge graph creation service (or “knowledge graph creator”) may be a service used to construct a knowledge graph 114 (or multiple knowledge graphs 114, although not shown in FIG. 1), such as from data 116 in storage 106 (or stored in memory 108, although not shown in FIG. 1). The knowledge graph creator may use all or a subset of data 116 to construct knowledge graph 114. In certain aspects, the knowledge graph creator utilizes one or more embedding models 110 and/or one or more large language models (LLMs) 112 to construct knowledge graph 114. Constructing the knowledge graph 114 using embedding model(s) 110 and/or LLM(s) 112 is described below with respect to FIG. 2.

In certain aspects, after creating the knowledge graph 114, the knowledge graph creator stores the knowledge graph 114 in memory 108 for use by one or more other microservices 104, such as first microservice 104(1). For example, in certain aspects, first microservice 104(1) queries knowledge graph 114 to generate one or more recommendations. In certain aspects, first microservice 104(1) may provide and/or make available the generated recommendations(s). For example, in certain aspects, first microservice 104(1) may provide the generated recommendation(s) to client device 150(1) and/or client device 150(2) for display on UI 152(1) and/or UI 152(2), respectively.

In certain aspects, the knowledge graph 114 is a product and service knowledge graph that captures the knowledge about products and/or services and their related entities. For example, knowledge graph 114 may identify relationships between pairs of products and/or services in data 116 that (1) represent a same item (e.g., are synonymous or duplicates of one another), (2) comprise one product that is a species of a genus of the other product (e.g., one product is a variant of the other product), and/or (3) comprise related items. In certain aspects, the pairs of products and/or services may include two products, two services, and/or a product and a service belonging to a same industry or different industries. Various recommendations may be generated by the knowledge graph creator when knowledge graph 114 is a product and service knowledge graph. For example, one recommendation may include an indication of one or more products and/or services generally sold and associated with an industry. As another example, one recommendation may include an indication of one or more businesses that sell one or more products and/or services.

Though FIG. 1 depicts each of first host 102(1), storage 106, client device 150(1), and client device 150(2) as single devices for ease of illustration, first host 102(1), storage 106, client device 150(1), and/or client device 150(2) may be embodied in different forms for different implementations. Further, though FIG. 1 depicts only two hosts 102 and two client devices 150, other embodiments may include more or less hosts 102 and/or client devices 150, and client devices 150 may use any combination of microservices 104 on any host 102 where microservices 104 are deployed

### Example Workflow for Creating a Knowledge Graph

FIG. 2 depicts an example workflow 200 for creating a knowledge graph. For example, workflow 200 may be used to create a knowledge graph for a particular domain without prior knowledge of classes, relationships, and/or attributes for the domain. Put differently, a knowledge graph created via workflow 200 for a particular domain may not be based on any ontology previously created for the domain. Instead, workflow 200 may use embedding model(s) 210 and LLM(s) 216 to create a knowledge graph, which beneficially obviates the need for an ontology. Embedding model(s) 210 may be example(s) of embedding model(s) 110 depicted and described above with respect to FIG. 1. Similarly, LLM(s) 216 may be example(s) of LLM(s) 112 depicted and described above with respect to FIG. 1.

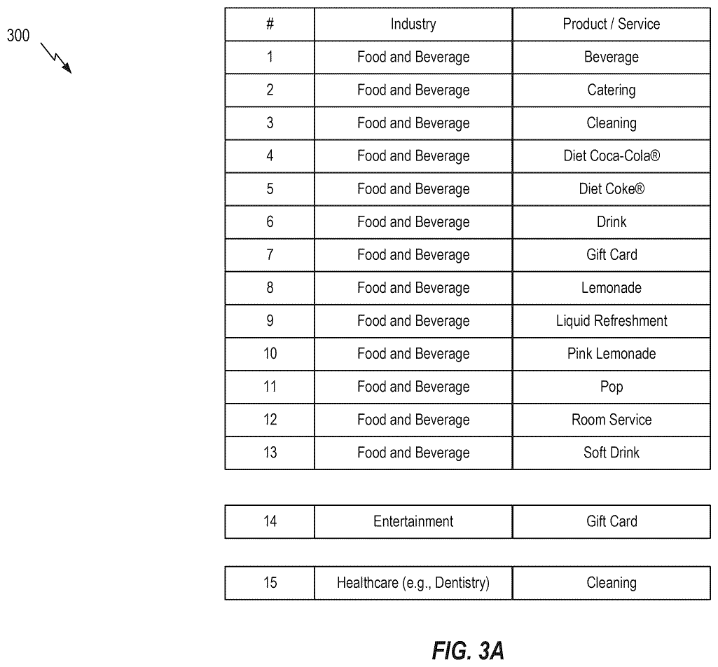

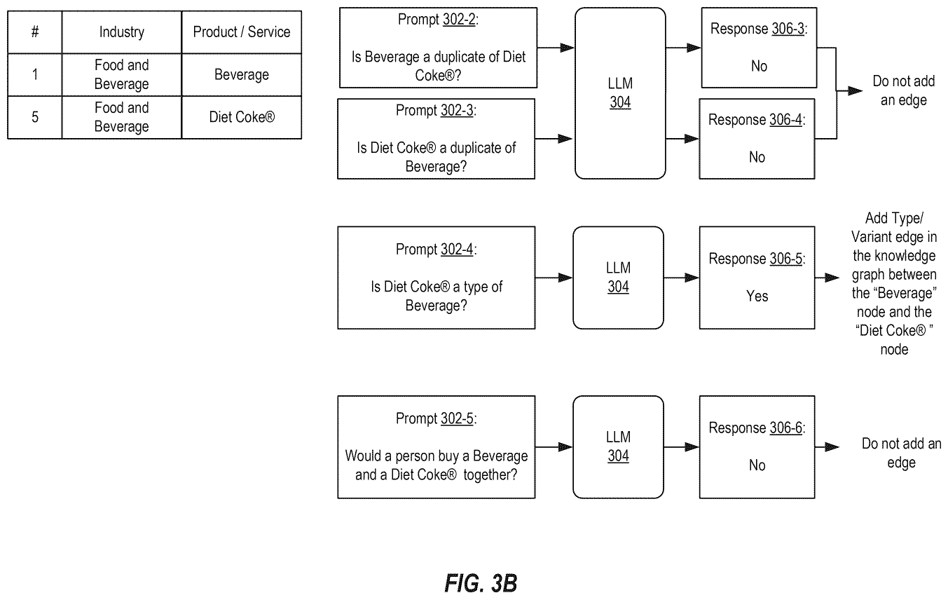

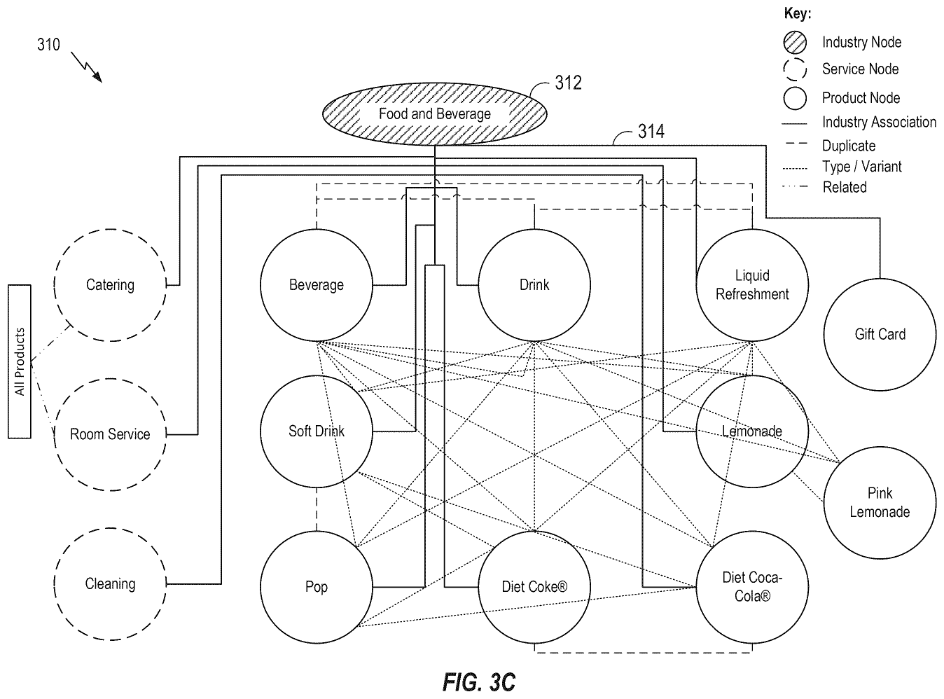

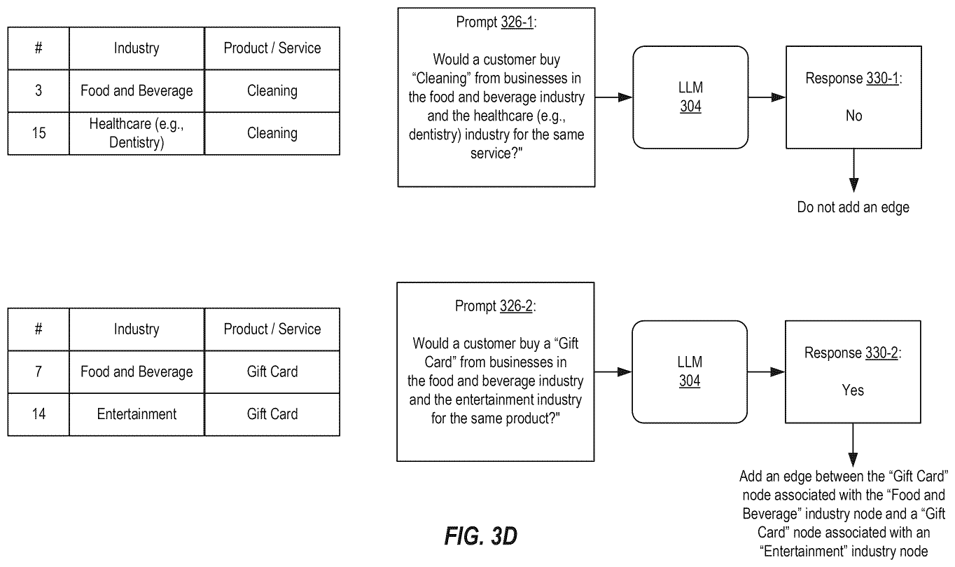

FIGS. 3A-3D depict the creation of an example product and service knowledge graph based on workflow 200 of FIG. 2. For example, a database 300 of fifteen entities shown in FIG. 3A may be used to create a product and service knowledge graph. The entities included in database 300 include multiple items associated with three industries: the food and beverage industry, the entertainment industry, and the healthcare industry (e.g., specifically with respect to dentistry). Thirteen of the fifteen items are associated with the food and beverage industry, one of the fifteen items is associated with the entertainment industry, and another one of the fifteen items is associated with the healthcare (e.g., dentistry) industry. Each of the fifteen items included in database 300 may comprise a product or a service associated with its respective industry.

Each of the fifteen items included in database 300 may represent an item entered into an application for a particular organization. For example, five organizations may use a same information service, such as the information service, implemented at first microservice 104(1) in FIG. 1, to keep track of the financial data. Each organization may enter their respective financial data into the information service. Thus, the fifteen items shown in FIG. 3A may represent data entry items entered into the information service by the five organizations. For example, a first organization may sell beverages (item #1) and gift cards (item #7), and may enter each of these items into the information service to keep track of their finances. A second organization may sell catering (item #2), cleaning (item #3), room service (item #4), and gift cards (item #7), and may enter each of these items into the information service to keep track of their finances. Similarly, the other three organizations may enter items, included in database 300, into the information service.

Data entry into the information service may not be limited. Put differently, an organization using the information service may be able to enter any amount and/or type of information. Thus, in some cases, two organizations selling the same or similar products and/or services may enter the products and/or services with different aliases. For example, a first organization may enter the item “beverage” into the information service, while a second organization may enter the item “liquid refreshment” into the information service. A beverage is synonymous with a liquid refreshment; however, this relationship between these item entries may not be present at the time of entry into the information service. Such relationships may instead be identified when creating a knowledge graph for the items in database 300 based on workflow 200.

The example product and service knowledge graph created for items in database 300 may include intra-industry awareness and inter-industry awareness. That is, the example product and service knowledge graph may be created to (1) encode the relationships between items belonging to a same industry, such as items 1-13 in database 300 belonging to the food and beverage industry, and (2) encode the relationships between items belonging to different industries, such as the food and beverage industry, the entertainment industry, and the healthcare industry. For example, FIG. 3C depicts the example product and service knowledge graph 310 that may be created for items 1-13 in database 300 to provide intra-industry awareness. This example product and service knowledge graph 310 may then be augmented with inter-industry knowledge to show relationships between one or more of these items included in the product and service knowledge graph 310 with item number 14 and/or item number 15 in database 300, such that the example product and service knowledge graph provides inter-industry awareness (this augmented example product and service knowledge graph is not shown in FIG. 3A-3D).

It is noted that FIGS. 2 and 3A-3D are described in conjunction below. Further, it is noted that FIGS. 3A-3D describe only one example knowledge graph that may be created based on workflow 200 of FIG. 2, and thus in other examples, workflow 200 may be used to construct other types of knowledge graphs for different domains, for different entities, for different industries, based on different prompting, and/or the like.

In FIG. 2, workflow 200 begins with obtaining entities 204 from one or more databases 202. Entities 204 may be associated with a particular domain. A knowledge graph may be created for entities 204 based on workflow 200 of FIG. 2.

Example database(s) 202 where entities 204 may be found may include an information service's database (e.g., such as a database of the information service implemented at the first microservice 104(1) in FIG. 1, such as a database from QuickBooks®). For example, the information service's database may include a table of products/services sold by businesses that use the information service. The entities 204 may be included in the table of products/services. In certain other aspects, the entities 204 may be included in the information service's database of transactions, where the transactions are categorized into one or more categories (e.g., rent, paycheck, restaurant, auto repair, etc.). In certain other aspects, the entities 204 may be included in the information service's database of employees (e.g., including a list of employee roles/titles). Other example database(s) 202 where entities 204 may be found may include database(s) of products/services sold via online platform(s) (e.g., such as Amazon®, Shopify®, eBay®, and/or Etsy®, to name a few).

In one example, the entities obtained include items 1-15 shown in FIG. 3A. As described above, items 1-15 may represent items included in a database 300 and associated with multiple organizations (e.g., businesses) associated with multiple industries. Items 1-15 may represent products and services that are sold by these organizations in different industries. In certain aspects, items 1-15 include unique item-industry pairs. For example, a first organization associated with the “Food and Beverage” industry may be associated with item number 1, “Beverage,” and a second organization associated with the “Food and Beverage” industry may also be associated with item number 1, “Beverage. ” Thus, instead of obtaining a first “Beverage” and “Food and Beverage” industry pair and a second “Beverage” and “Food and Beverage” industry pair from database 300, only one “Beverage” and “Food and Beverage” industry pair may be obtained and used for the knowledge graph creation. It is noted, however, that an item associated with a first industry and obtained from database 300 may comprise a different item-industry pair than a same item associated with a second industry and obtained from database 300. For example, when a “Beverage” item is sold by both a the “Food and Beverage” industry and the “Entertainment” industry, then a first pair, e.g., a “Beverage” and “Food and Beverage” industry pair, and a second pair, e.g., “Beverage” and “Entertainment” industry pair, may exist for item “Beverage.”

In certain aspects, workflow 200 is used to create a knowledge graph with intra-industry awareness. In certain aspects, workflow 200 is used to create a knowledge graph with inter-industry awareness. In certain aspects, workflow 200 is used to create a knowledge graph with both intra and inter-industry awareness. For the example depicted in FIGS. 3A-3D, workflow 200 is used to create a knowledge graph with both intra and inter-industry awareness.

Beginning with intra-industry knowledge graph creation, workflow 200 proceeds with embedding component 206 generating multiple vector embeddings for the obtained entities 204 and storing the generated vector embeddings in a vector database. For example, one vector embedding may be generated for each entity 204 and stored in the vector database. In certain aspects, the vector embedding may be generated using one or more embedding models 210. An embedding generated for an entity 204 may comprise a numerical representation of the entity 204, capturing its underlying meaning. Including the embeddings in the vector database may help to capture structural and/or semantic relationships between the embeddings (e.g., more specifically, between the entities 204).

For example, in FIG. 3A, embedding component 206 may use one or more embedding models 210 to generate fifteen embeddings for the fifteen items. A first vector embedding may be generated for the first item “Beverage,” a second vector embedding may be generated for the second item “Catering,”and so on. These vector embeddings may be stored in a vector database.

In FIG. 2, workflow 200 then proceeds with an embedding similarity search component 208 identifying and generating a set of semantically similar entities for each respective entity 204. For example, in certain aspects, the vector database may be queried to identify the top similar entities to each respective entity 204 obtained for the knowledge graph creation (e.g., where N is an integer greater than zero). A set of semantically similar entities for a respective entity 204 may include the top N entities determined to be similar to the respective entity 204. In certain aspects, the set of semantically similar entities for a respective entity 204 may include the top N entities determined to be similar to the respective entity 204, and which share a similar attribute, such as belonging to a same industry. In certain aspects, the semantic similarity is determined between a pair of entities 204 by comparing the entities'vector embeddings, or more specifically, computing a similarity between the entities 204 based on how close their vector embeddings are in the vector space.

In certain embodiments, the comparison between entities 204 is performed by determining a distance metric between their embeddings. The distance metric may be calculated, for example, as a Euclidean distance, where a Euclidean distance is the length of a segment connecting (e.g., a straight line distance between) two points in either a plane or in a multi-dimensional space, as a cosine similarity metric, a Manhattan distance metric, and/or the like. A small distance metric calculated between the embeddings may indicate that the entities 204, associated with the embeddings, are likely related. Alternatively, a large distance metric calculated between the embeddings may indicate that the entities 204, associated with the embeddings, are likely not related.

For example, in FIG. 3A, the vector database may be queried to generate a first set of semantically similar items to the first item “Beverage,” generate a second set of semantically similar items to the second item “Catering,” generate a third set of semantically similar items to the third item “Cleaning,” and so on. The first set of semantically similar items to the first item “Beverage,” may include one or more items determined to be similar to the first item “Beverage” and which belong to the food and beverage industry (e.g., a same industry associated with the first item “Beverage”). The second set of semantically similar items to the second item “Catering,” may include one or more items determined to be similar to the second item “Catering” and which belong to the food and beverage industry (e.g., a same industry associated with the second item “Catering”). The third set of semantically similar items to the third item “Cleaning,” may include one or more items determined to be similar to the third item “Cleaning” and which belong to the food and beverage industry (e.g., a same industry associated with the first item “Beverage,” and so one for each of the other twelve items listed in FIG. 3A).

As an illustrative example, the first set of semantically similar items to the first item “Beverage” may include item 4 “Diet Coca-Cola®,” item 5 “Diet Coke®,” item 6 “Drink,” item 8 “Lemonade,” item 9 “Liquid Refreshment,” item 10 “Pink Lemonade,” item 11 “Pop,” and item 13 “Soft Drink. ” Each of items 4, 5, 6, 8, 9, 10, 11, and 13 may be associated with the food and beverage industry, which is a same industry associated with the first item “Beverage. ”

In FIG. 2, workflow 200 then proceeds with an association determination component 214 determining whether an entity 204 is associated with at least one entity 204 in the set of semantically similar entities generated for the entity 204. This determination may be performed for each entity used to generate the knowledge graph. This determination may be performed to identify relationship(s) between entities sharing at least a same attribute, such as belonging to a same industry.

In certain aspects, the association determination component 214 determines the association between a first entity and a semantically similar entity (e.g., in the set of semantically similar entities generated for the first entity) to the first entity (e.g., determined by embedding similarity search component 208) using one or more LLMs 216.

As a first example, in certain aspects, an LLM 216 may be prompted to determine if the first entity and a semantically similar entity to the first entity are the same entity. For example, an LLM 216 may be prompted to generate a first response indicating whether the first entity is a duplicate of the semantically similar entity. Next, the LLM 216 may be prompted to generate a second response indicating whether the semantically similar item is a duplicate of the first entity. If the first response indicates that the first entity is a duplicate of the semantically similar entity, and the second response indicates that the semantically similar item is a duplicate of the first entity, then the first entity and the semantically similar entity may comprise the same entity (e.g., the first item and the semantically similar item are associated based on both entities comprising the same entity). Thus, the first entity and the semantically similar entity may have the same underlying meaning and usage (e.g., in the same industry).

As a second example, in certain aspects, an LLM 216 may be prompted to determine if a semantically similar entity to the first entity is a specie of a genus of the first entity. As used herein, a genus may comprise a group of related entities. For example, an LLM 216 may be prompted to generate a response indicating whether the semantically similar entity is an example type and/or variant of the first entity.

As a third example, in certain aspects, an LLM 216 may be prompted to determine if the first entity is related to a semantically similar entity to the first entity. For example, an LLM 216 may be prompted to generate a response indicating whether the first entity and the semantically similar entity are entities that are generally purchased together. For example, a “toothbrush” entity may be related to a “toothpaste” entity given these entities are generally purchased together. As another example, an LLM 216 may be prompted to generate a response indicating whether a person buying the first item may also be inclined to buy the semantically similar entity at the same time. For example, a semantically similar entity likely to be purchased with the first entity may comprise a related entity to the first entity. For example, a “fabric softener” entity is likely to be purchased with the purchase of a “detergent”entity; thus, these entities may be related.

In certain aspects, additional information may also be provided to LLM 216 to aid LLM 216 in identifying whether entities are related. For example, in this example, additional information may be provided to LLM 216 to aid LLM 216 in identifying whether a person buying the first item may also be inclined to buy the semantically similar entity at the same time. In certain aspects, this additional information is provided to LLM 216 using retrieval-augmented generation (RAG). RAG is an information retrieval (IR) approach that combines the power of LLM(s) with external knowledge sources to generate more informed and/or contextually relevant responses. For example, a RAG system may be designed with a retrieval-based component and a generative component. The retrieval-based component may retrieve relevant documents, passages, and/or text from a database (e.g., a vector database) and/or corpus based on receiving a prompt (or input query). The retrieved documents, passages, and/or text may be concatenated as context with the original prompt and fed to the generative component (e.g., a text generator) of the RAG system, which in turn produces text output for the input query. By combining the prompt with the contextual documents, the LLM receives a comprehensive input that incorporates both the original prompt and the relevant information from external sources. The relevant information may be information (e.g., which in some cases may be incomplete), which helps to augment the general knowledge of the LLM.

In certain aspects, if a first item and a semantically similar item are determined to comprise the same item, then the LLM may not be prompted to determine (1) whether the semantically similar item is a specie of a genus of the first item and (2) whether the entities are related. In certain aspects, if a first item and a semantically similar item are determined not to comprise the same item, but the semantically similar item is determined to be a specie of a genus of the first item, then the LLM may not be prompted to determine whether the entities are related.

FIG. 3B illustrates the example prompts that may be provided to an LLM 304 (e.g., an example of LLM 216 in FIG. 2) to determine if a first item and a semantically similar item to the first item are associated. For example, as shown in FIG. 3B, item 5 “Diet Coke®,” may be determined to be semantically similar to item 1 “Beverage” in the food and beverage industry. To determine the association between item 1 “Beverage” and item 5 “Diet Coke®,” LLM 304 may first be prompted to determine whether item 1 “Beverage” and item 5 “Diet Coke®” comprise a same item. For example, first, LLM 304 may be prompted to generate a response 306-3 to prompt 302-2 indicating whether item 1 “Beverage” is a duplicate of item 5 “Diet Coke®. ” Second, LLM 304 may be prompted to generate a response 306-2 to prompt 302-3 indicating whether item 5 “Diet Coke®” is a duplicate of item 1 “Beverage. ” In this example, response 306-3 indicates that item 1 “Beverage” is not a duplicate of item 5 “Diet Coke®,” and response 306-4 indicates that item 5 “Diet Coke®” is not a duplicate of item 1 “Beverage. ” As such, item 1 “Beverage” and item 5 “Diet Coke®”may not comprise the same item.

Next, LLM 304 may be prompted to generate a response 306-5 to prompt 302-4 indicating whether “Diet Coke®” is a type of “Beverage,” or in other words, if “Diet Coke®” is a specie of a genus of “Beverage. ” In this example, response 306-5 indicates that “Diet Coke®” is a type of “Beverage” or a specie of the genus of “Beverage. ” Thus, item 5 “Diet Coke®” may be associated with item 1 “Beverage” based at least on the fact that “Diet Coke®” is a type of Beverage of a specie of the genus of “Beverage.”

In some cases, after determining that item 1 “Beverage” and item 5 “Diet Coke®” are associated, LLM 304 may not need to be prompted again. However, in some other cases, after determining that item 5 “Diet Coke®” is a type of item 1 “Beverage” or a specie of the genus of item 1 “Beverage,” LLM 304 may again be prompted to generate a response 306-6 indicating whether item 1 “Beverage” is related to item 5 “Diet Coke®,” or more specifically generate a response 306-6 indicating whether a person would buy item 1 “Beverage” and item 5 “Diet Coke®” together. In this example, response 306-6 may indicate that item 1 “Beverage” and item 5 “Diet Coke®”are not typically bought together.

Similar prompting may also be performed for other items determined to be semantically similar to item 1 “Beverage” to determine an association, if any, between item 1 “Beverage” and any of the other semantically similar items. Further, similar prompting may also be performed for item 2 “Catering” and each semantically similar item in the second set of semantically similar items associated with item 2 “Catering,” item 3 “Cleaning” and each semantically similar item in the third set of semantically similar items associated with item 3 “Cleaning,” and so on. As such, all pairs of semantically similar items among items 1-13 may be analyzed to determine if each pair of semantically similar items comprises associated items.

In FIG. 2, after determining the association between different semantically similar entities, workflow 200 then proceeds with a knowledge graph creation component 218 generating a knowledge graph based on the determined associations between entities 204. For example, knowledge graph creation component 218 may generate a knowledge graph including multiple interconnected nodes. A node may be created in the knowledge graph for each of the entities 204 used to create the knowledge graph. Further, in certain aspects, other node types, such as industry node(s) may be added to the knowledge graph to represent different industry(ies) that the industry node(s) are associated with. Edges between a pair of nodes in the knowledge graph may be added based determining an association exists between an entity associated with one node in the pair and another entity associated with the other node in the pair. In certain aspects, different edge types may be added between different node pairs indicating the different associations between entities associated with the node pairs.

For example, in FIG. 3C, a product and service knowledge graph 310 may be created by knowledge graph creation component 218, at least based on entities 1-13 shown in FIG. 3A. For example, the knowledge graph creation component 218 may generate product and service knowledge graph 310 with multiple nodes 312 and edges 314.

Example nodes 312 included in product and service knowledge graph 310 may include an industry node and item nodes. In certain aspects, the item nodes may include service nodes and product nodes. For example, for each entity 1-13 in FIG. 3A, a node 312 may be added to product and service knowledge graph 310. In certain aspects, an LLM may be prompted to determine if an entity is a product or a service. If the entity is characterized as a product, then a product node may be added to product and service knowledge graph 310. Alternatively, if the entity is characterized as a service, then a service node may be added to product and service knowledge graph 310. Although in this example illustrated in FIG. 3C, the product/service knowledge is captured in knowledge graph 310 based on the shape of the nodes 312, in certain other aspects, this information may be captured in knowledge graph 310 in different ways, such as via the use of additional text associated with each node 312 in knowledge graph 310, and/or this information may not be captured in knowledge graph 310.

In certain aspects, the product/service information is leveraged to generate recommendation(s) when using knowledge graph 310. As an illustrative example, businesses in the fitness/gym industry may generally sell products, such as supplements, and services, such as training and/or group classes. If one particular business in that industry, however, completely operates online and only sells products, then the product/service information may be used to filter out entities associated with business that provide services from the knowledge graph such that only entities of businesses that sell products remain. One or more recommendations may be generated based on the remaining entities.

For example, in FIG. 3C, thirteen item nodes may be added to product and service knowledge graph 310 to represent the thirteen entities, shown in FIG. 3A, associated with the food and beverage industry. Items 2, 3, and 12 may be identified as services (e.g., using an LLM); thus, three of the item nodes may include service nodes. Further, items 1, 4-11, and 13 may be identified as products (e.g., using an LLM); thus, nine of the item nodes may include product nodes. Further, an industry node associated with the food and beverage industry may be added to the product and service knowledge graph 310.

The food and beverage industry node may be connected to each of the thirteen items nodes in the product and service knowledge graph 310 via a respective edge, based on each of the item nodes being associated with (e.g., being sold in) the food and beverage industry. Further, one or more other edges may be added between pairs of the items nodes. In certain aspects, an edge representing duplicate items may be added between item nodes associated with items determined to be associated, and more specifically, determined to comprise the same item (e.g., such as by prompting LLM 304 with prompts 302-2 and 302-3, as depicted and described with respect to FIG. 3B). In certain aspects, an edge representing an entity which is a variant or type of another entity may be added between item nodes associated with one entity determined to be a specie of a genus for another entity associated with the other node in the pair of nodes (e.g., e.g., such as by prompting LLM 304 with prompt 302-4, as depicted and described with respect to FIG. 3B). In certain aspects, an edge representing related items may be added between item nodes associated with items determined to be related (e.g., such as by prompting LLM 304 with prompt 302-4, as depicted and described with respect to FIG. 3B). Although not shown, in certain aspects, multiple edges may be added between a single pair of nodes 312 in product and service knowledge graph 310.

Returning to FIG. 2, in some cases, one or more of entities 204 used to create the knowledge graph are associated with at least one different attribute. For example, one or more entities 204 may be associated with different industries. To capture relationships between entities associated with different industries, workflow 200 may additionally perform inter-industry graph creation.

For example, for inter-industry graph creation, workflow 200 may additionally include a matching component 212 identifying entities 204 belonging to different industries that comprise matching entities. For example, matching component 212 may use embeddings generated by embedding component 206 to identify matching entities across industries. For each matching entity, matching component 212 may create a list of all industries associated with the matching entity. In certain aspects, matching entities may include at least two entities that textually represent a same entity. In certain aspects, matching component 212 leverages additional information from external source(s), such as one or more databases, in addition to the embeddings to identify matching entities across industries.

For example, in FIG. 3A, matching component 212 may determine that item “gift card” is associated with two industries: the food and beverage industry and the entertainment industry (e.g., shown as items 7 and 14 in database 300). Further, matching component 212 may determine that item “Cleaning” is also associated with two industries: the food and beverage industry and the healthcare (e.g., dentistry) industry (e.g., shown as items 3 and 15 in database 300).

Returning to FIG. 2, workflow 200 then proceeds with the association determination component 214 determining whether a matching entity associated with a first industry is a same entity as the matching entity associated with a second industry. Association determination component 214 may make this determination for each matching entity associated with two different industries. If a matching entity in a first industry is determined to be the same entity as the matching entity in the second industry, then the matching entity in the first industry and the matching entity in the second industry may be associated.

For example, in FIG. 3D, matching entity (or matching item) “Cleaning” may be determined to be associated with both the food and beverage industry as well as the healthcare (e.g., density) industry. To determine if item 3 “Cleaning” associated with the food and beverage industry is the same item as the item 15 “Cleaning” associated with the healthcare (e.g., dentistry) industry, LLM 304 may be used. For example, LLM 304 may be prompted to generate a response 330-1 to prompt 326-1 indicating whether a customer would buy “Cleaning” from businesses in the food and beverage industry and the healthcare (e.g., dentistry) industry for the same service. In this example, as shown via response 330-1 in FIG. 3D, “Cleaning” in the food and beverage industry and “Cleaning” in the healthcare (e.g., dentistry) industry are not related to a same service. Specifically, LLM 304 may recognize that “Cleaning” in the food and beverage industry may relate to refer to the task of removing dirt, marks, and/or mess from an environment, while “Cleaning” in the healthcare (e.g., dentistry) industry may relate to a regular dental cleaning. Thus, item “Cleaning” may not be the same across the two industries, and further not association may be established between item 3 “Cleaning” associated with the food and beverage industry is the same item as the item 15 “Cleaning”associated with the healthcare industry.

For example, in FIG. 3D, matching entity (or matching item) “Gift Card” may be determined to be associated with both the food and beverage industry as well as the entertainment industry. To determine if item 7 “Gift Card” associated with the food and beverage industry is the same item as the item 14 “Gift Card” associated with the entertainment industry, LLM 304 may be used. For example, LLM 304 may be prompted to generate a response 330-2 to prompt 326-2 indicating whether a customer would buy a “Gift Card” from businesses in the food and beverage industry and the entertainment industry for the same product. In this example, as shown via response 330-1 in FIG. 3D, a “Gift Card” in the food and beverage industry and a “Gift Card” in the entertainment industry may be related to a same product. Specifically, LLM 304 may recognize that a “Gift Card” in the food and beverage industry constitutes the same item as a “Gift Card” in the entertainment industry (e.g., a prepaid card that can be used as a form of payment to make purchases). Thus, item “Gift Card” may be the same across the two industries, and an association may be established between item 7 “Gift Card” associated with the food and beverage industry is the same item as the item 14 “Gift Card”associated with the entertainment industry.

In FIG. 2, after determining the association(s) between different entities associated with different industries (if any), workflow 200 then proceeds with knowledge graph creation component 218 generating nodes and/or edges in a knowledge graph (e.g., such as a knowledge graph previously-created to capture intra-industry knowledge) to capture these association(s). For example, an item node may be added in the knowledge graph for each of the entities 204 that have not yet been added to the knowledge graph. Further, an industry node may be added in the knowledge graph for any industries that have not yet been added to the knowledge graph. Further, one or more edges may be added between node pairs associated with different entities in the knowledge graph that are determined to be associated (e.g., based on association determination component 214 determining the association between such node pairs).

For example, in FIG. 3C (although not shown), to incorporate inter-industry knowledge, the product and service knowledge graph may be augmented to include at least a new item node (e.g., product node) for item 14 “Gift Card” associated with the entertainment industry, a new item node (e.g., service node) for item 15 “Cleaning” associated with the healthcare (e.g., dentistry) industry, a first new industry node associated with the “Entertainment” industry, and a second new industry node associated with the “Healthcare” industry, which are listed in database 300 in FIG. 3A. Further, an edge may be added to connect the item node associated with item 14 “Gift Card” associated with the entertainment industry and the item node associated with item 7 “Gift Card” associated with the food and beverage industry. No edge may be added between the service node associated with item 15 “Cleaning” associated with the healthcare industry and the service node associated with item 2 “Cleaning”associated with the food and beverage industry.

In certain aspects, after knowledge graph creation component 218 creates the knowledge graph, a recommendation component 220 may query the knowledge graph to generate one or more predictions. In certain aspects, recommendation component 220 further provides and/or makes available (e.g., such as generates for display) the one or more recommendations. In certain aspects, recommendation component 220 queries the knowledge graph and provides the generated recommendation(s) based on receiving a request for the recommendation(s).

In certain aspects, the one or more recommendations may include an indication of one or more organizations (e.g., businesses) that sell an item included in the knowledge graph. As an illustrative example, a consumer may want to buy a book titled “Artificial Intelligence, First Edition.” A first company and a second company each sell the book and enter sales for this book as different entities into an information service, such as information service such as the information service implemented at first microservice 104(1) in FIG. 1, to keep track of their respective sales (e.g., the example information may include QuickBooks®). For example, a first entity associated with the first company, and included in the data maintained for the information service, may list the book as “Artificial Intelligence, First Edition.” Further, a second entity associated with the second company, and included in the data maintained for the information service, may list the book as “Artificial Intelligence, 1st Edition.” A knowledge graph created according to workflow 200 described above may realize that the first entity and the second entity are the same. Thus, when receiving the user's request to buy the book “Artificial Intelligence, First Edition” the system may provide both the first company and the second company as a recommendation of places where the user may purchase the book.

In certain aspects, the one or more recommendations comprise an indication of one or more items generally sold and associated with a particular industry. For example, when a business first begins using an information service, such as Quickbooks®, the business may set up a profile and indicate that they are a restaurant in the food and beverage industry. To ease the process of starting of business and help the restaurant get up and running, the knowledge graph may recommend one or products and/or services that are generally sold by similar businesses in the food and beverage industry. This recommendation may be generated based on identifying other businesses in the same food and beverage industry and the types of products and/services that are generally sold by these businesses.

In certain aspects, one or more validation methods may be used to verify the accuracy of a knowledge graph created using the techniques described above. For example, in certain aspects, multiple LLMs may be used to determine the association(s) between entities. For instance, each step where an LLM is prompted, as described above, may be performed against multiple ML models (e.g. such as GPT-4®, Claude Opus, Mistral, etc.). Multiple ML models agreeing/producing a same output may increase the confidence associated with that particular output (e.g., such as the confidence that two entities are associated and thus, an edge should be added to the knowledge graph between the two entities). For example, multiple ML models may be prompted to each generate a respective response indicating whether an entity and a semantically similar entity of the entity are associated. The determination that the entity and the semantically similar entity are associated or not may be based on the respective response generated by each ML model.

In certain aspects, an LLM may be prompted with different prompts (essentially asking the same thing) to test/determine if the LLM returns the same result. For example, an LLM (or multiple ML models) may be prompted with a plurality similar prompts to generate a respective response to each of the respective similar prompts, such as indicating whether an association exists between two entities. The determination that the two entities are associated or not may be based on the respective response generated by the LLM (or multiple ML models) to each similar prompt.

In certain aspects, a knowledge graph created using the techniques described above may be deployed, and user feedback may be gathered to learn about one or more problems/issues associated with the knowledge graph. The feedback may be explicit (e.g. users ranking knowledge graph components, such as with thumbs up/down, by flagging an issue, and/or providing corrections) or implicit (e.g. using tracking data indicating if and/or how users are using knowledge graph components within a product/application).

In certain aspects, if validation fails or results in a confidence less than a desired confidence threshold, then one or more actions may be taken. For example, the action(s) may include, accepting the response (e.g., answer) of the largest majority of ML models prompted with a same prompt, weighting certain ML models as being more trustworthy than others, electing not to add an association between entities to the knowledge graph, as an edge in the knowledge graph, and/or reporting controversial issues to a human reviewer to resolve, among others.

### Example Method for Creating a Knowledge Graph

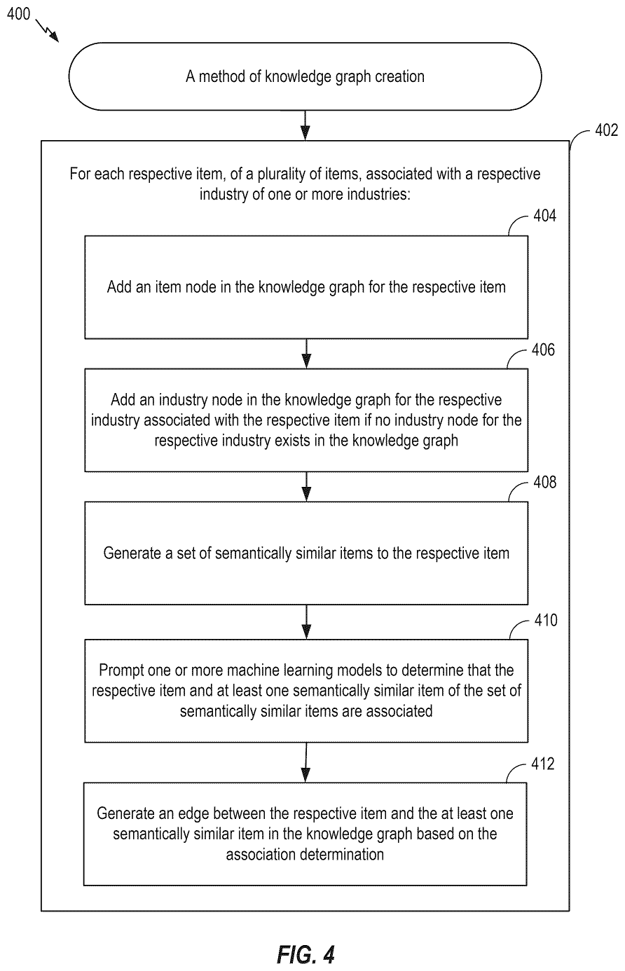

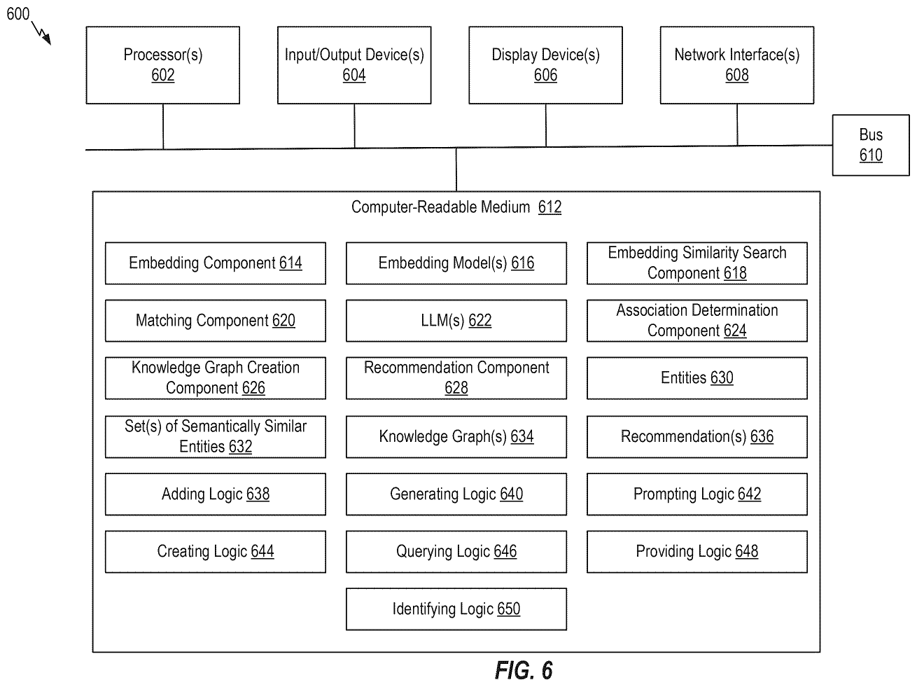

FIG. 4 depicts an example method 400 for knowledge graph creation. In one aspect, method 400 can be implemented by the system 100 of FIG. 1 and/or processing system 600 of FIG. 6.

Method 400 begins, at block 402, with for each respective item, of a plurality of items, associated with a respective industry of one or more industries, performing steps at blocks 404-410.

Method 400 proceeds, at block 404, with adding an item node in the knowledge graph for the respective item.

Method 400 proceeds, at block 406, with adding an industry node in the knowledge graph for the respective industry associated with the respective item if no industry node for the respective industry exists in the knowledge graph.

Method 400 proceeds, at block 408, with generating a set of semantically similar items to the respective item.

Method 400 proceeds, at block 410, with prompting one or more machine learning models to determine that the respective item and at least one semantically similar item of the set of semantically similar items are associated.

Method 400 proceeds, at block 412, with generating an edge between the respective item and the at least one semantically similar item in the knowledge graph based on the association determination.

In certain aspects, method 400 further includes: generating a plurality of vector embeddings for the plurality of items and storing the plurality of vector embeddings in a vector database, wherein each respective vector embedding of the plurality of vector embeddings represents a respective item of the plurality of items in a vector space; and querying the vector database to generate the set of semantically similar items to the respective item.

In certain aspects, each respective item associated with the respective industry comprises a unique item-industry pair.

In certain aspects, prompting, at block 410, comprises prompting the one or more machine learning models to determine that the respective item and the at least one semantically similar item are a same item.

In certain aspects, prompting the one or more machine learning models to determine that the respective item and the at least one semantically similar item are the same item comprises: prompting the one or more machine learning models to generate a respective first response indicating that the respective item is a duplicate of the at least one semantically similar item; and prompting the one or more machine learning models to generate a respective second response indicating that the at least one semantically similar item is a duplicate of the respective item.

In certain aspects, prompting, at block 410, comprises prompting the one or more machine learning models to determine that the at least one semantically similar item is a specie of a genus of the respective item.

In certain aspects, prompting, at block 410, comprises prompting the one or more machine learning models to determine that the respective item and the at least one semantically similar item are associated comprises prompting the one or more machine learning models to determine that the respective item is related to the at least one semantically similar item.

In certain aspects, prompting the one or more machine learning models comprises prompting a plurality of machine learning models to each generate a respective response indicating that the respective item and the at least one semantically similar item of the set of semantically similar items are associated, and the determination by the one or more machine learning models is based on the respective response generated by each respective machine learning model of the plurality of machine learning models.

In certain aspects, the one or more machine learning models comprise one or more large language models (LLMs).

In certain aspects, prompting the one or more machine learning models includes prompting a single machine learning model with a plurality similar prompts to generate a respective response to each of the respective similar prompts, and the determination by the one or more machine learning models is based on the respective response generated for each respective similar prompt of the plurality of similar prompts.

In certain aspects, method 400 further includes prompting the one or more machine learning models to determine if the respective item is a product or a service.

In certain aspects, method 400 further includes for each respective item of the plurality of items, adding an edge between the item node associated with the respective item and the industry node associated with the respective industry associated with the respective item.

In certain aspects, the one or more industries comprise a plurality of industries; and the method further comprises: identifying a set of items of the plurality of items that textually represent a same item, the set of items being associated with a set of industries of the plurality of industries; and prompting one or more machine learning models to determine that at least one respective item, in the set of items, that is associated with a first industry of the set of industries is a same item as another item sold associated with a second industry of the set of industries; and generating an edge in the knowledge graph between the at least one respective item and the other item if no edge exists between the at least one respective item and the other item based on the determination that the at least one respective item is the same item as the other item.

In certain aspects, method 400 further includes: providing one or more recommendations based on the knowledge graph, the one or more recommendations comprising an indication of at least one of: one or more businesses that sell an item of the plurality of items included in the knowledge graph; or one or more items of the plurality of items generally sold and associated with an industry of the one or more industries.

In certain aspects, a first industry of the one or more industries comprises a food and beverage industry, and a set of items of the plurality of items associated with the food and beverage industry comprise one or more of: a beverage; a drink; a liquid refreshment; a soft drink; a pop; a Diet Coke®; a Diet Coca-Cola®; a lemonade; a pink lemonade; a gift card; a catering service; room service; or a cleaning service.

As described herein, leveraging the capabilities of embedding model(s) and LLM(s) to create knowledge graphs, thus provide significant technical advantages over conventional solutions, such as the ability carry out the creation of a knowledge graph for a particular domain without requiring prior information about the domain. Further, the use of the embedding model(s) and LLM(s) to identify associations between different items for creation of the knowledge graph may result in the creation of a more accurate knowledge graph, which may be used by one or more applications. This improved knowledge graph may enhance the performance of any of these application(s) that rely on this knowledge graph for performing various tasks, such as providing one or more recommendations.

Note that FIG. 4 is just one example of a method, and other methods including fewer, additional, or alternative operations are possible consistent with this disclosure.

### Example Method for Providing Recommendation(s) Using a Knowledge Graph

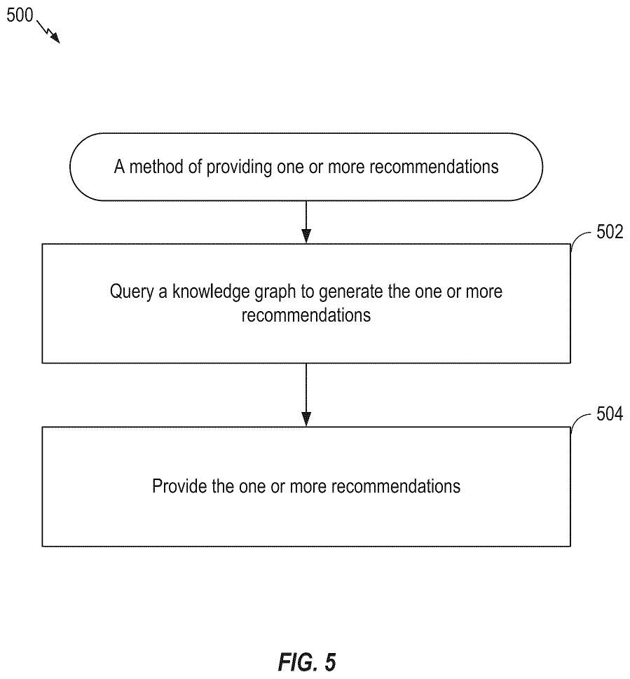

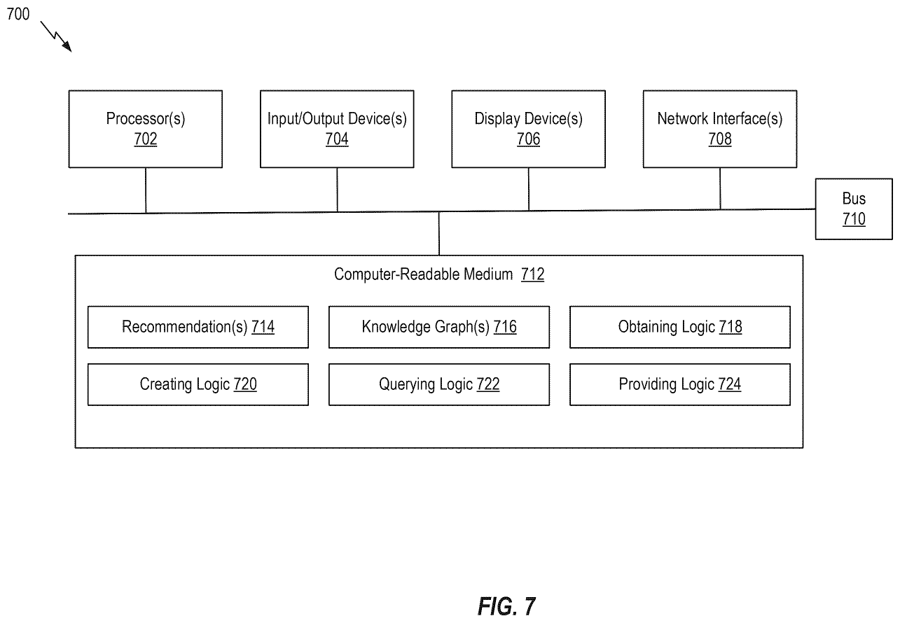

FIG. 5 depicts an example method 500 for providing one or more recommendations. In one aspect, method 400 can be implemented by the system 100 of FIG. 1 and/or processing system 700 of FIG. 7.

Method 500 begins, at block 502, with querying a knowledge graph to generate the one or more recommendations. The knowledge graph may include a plurality of item nodes associated with a plurality of items, one or more industry nodes associated with the one or more industries, and a plurality of edges. Each respective item, of the plurality of items, are associated with a respective industry of one or more industries and each respective item associated with the respective industry may be a unique item-industry pair. Each respective edge of the plurality of edges may connect a respective pair of items nodes of the plurality of item nodes. Each respective edge may indicate that the respective items associated with the respective pair of item nodes comprise: associated items in a same industry of the one or more industries that are associated, or associated items in different industries of the one or more industries; and providing the one or more recommendations.

Method 500 proceeds, at block 504, with providing the one or more recommendations.

In certain aspects, the one or more recommendations include an indication of one or more businesses that sell an item of the plurality of items included in the knowledge graph.

In certain aspects, the one or more recommendations include an indication of one or more items of the plurality of items generally sold and associated with an industry of the one or more industries.

In certain aspects, each respective edge indicating that the items of the respective pair of item nodes comprise the associated items in the same industry comprises an edge indicating that the respective items associated with the respective pair of item nodes comprise: a same item; a specie of a genus associated with the respective items; or related items.

In certain aspects, each respective item of the plurality of items comprises a product or a service.

In certain aspects, method 500 further includes creating the knowledge graph.

In certain aspects, a first industry of the one or more industries comprises a food and beverage industry, and a set of items of the plurality of items associated with the food and beverage industry comprise one or more of: a beverage; a drink; a liquid refreshment; a soft drink; a pop; a Diet Coke®; a Diet Coca-Cola®; a lemonade; a pink lemonade; a gift card; a catering service; room service; or a cleaning service.

The knowledge graph may enhance the performance of any of application(s) that rely on this knowledge graph for performing various tasks, such as providing one or more recommendations. For example, the knowledge graph may provide valuable insights about the relationships between different items, such that more complete and/or more accurate recommendation(s) may be provided.

Note that FIG. 5 is just one example of a method, and other methods including fewer, additional, or alternative operations are possible consistent with this disclosure.

### Example Processing System for Knowledge Graph Creation

FIG. 6 depicts an example processing system 600 configured to perform various aspects described herein, including, for example, method 400 as described above with respect to FIG. 4.

Processing system 600 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 600 includes one or more processors 602, one or more input/output devices 604, one or more display devices 606, one or more network interfaces 608 through which processing system 600 is connected to one or more networks (e.g., a local network, an intranet, the Internet, or any other group of processing systems communicatively connected to each other), and computer-readable medium 612. In the depicted example, the aforementioned components are coupled by a bus 610, which may generally be configured for data exchange amongst the components. Bus 610 may be representative of multiple buses, while only one is depicted for simplicity.

Processor(s) 602 are generally configured to retrieve and execute instructions stored in one or more memories, including local memories like computer-readable medium 612, as well as remote memories and data stores. Similarly, processor(s) 602 are configured to store application data residing in local memories like the computer-readable medium 612, as well as remote memories and data stores. More generally, bus 610 is configured to transmit programming instructions and application data among the processor(s) 602, display device(s) 606, network interface(s) 608, and/or computer-readable medium 612. In certain embodiments, processor(s) 602 are representative of a one or more central processing units (CPUs), graphics processing unit (GPUs), tensor processing unit (TPUs), accelerators, and other processing devices.

Input/output device(s) 604 may include any device, mechanism, system, interactive display, and/or various other hardware and software components for communicating information between processing system 600 and a user of processing system 600. For example, input/output device(s) 604 may include input hardware, such as a keyboard, touch screen, button, microphone, speaker, and/or other device for receiving inputs from the user and sending outputs to the user.

Display device(s) 606 may generally include any sort of device configured to display data, information, graphics, user interface elements, and the like to a user. For example, display device(s) 606 may include internal and external displays such as an internal display of a tablet computer or an external display for a server computer or a projector. Display device(s) 606 may further include displays for devices, such as augmented, virtual, and/or extended reality devices. In various embodiments, display device(s) 606 may be configured to display a graphical user interface.

Network interface(s) 608 provide processing system 600 with access to external networks and thereby to external processing systems. Network interface(s) 608 can generally be any hardware and/or software capable of transmitting and/or receiving data via a wired or wireless network connection. Accordingly, network interface(s) 608 can include a communication transceiver for sending and/or receiving any wired and/or wireless communication.

Computer-readable medium 612 may be a volatile memory, such as a random access memory (RAM), or a nonvolatile memory, such as nonvolatile random access memory (NVRAM), or the like. In this example, computer-readable medium 612 includes an embedding component 614, embedding model(s) 616, an embedding similarity search component 618, a matching component 620, LLM(s) 622, an association determination component 624, a knowledge graph creation component 626, a recommendation component 628, entities 630, set(s) of semantically similar entities 632, knowledge graph(s) 634, recommendation(s) 636, adding logic 638, generating logic 640, prompting logic 642, creating logic 644, querying logic 646, providing logic 648, and identifying logic 650.

In certain aspects, adding logic 638 includes logic for adding an item node in the knowledge graph for the respective item. In certain aspects, adding logic 638 includes logic for adding an industry node in the knowledge graph for the respective industry associated with the respective item if no industry node for the respective industry exists in the knowledge graph. In certain aspects, adding logic 638 includes logic for each respective item of the plurality of items, adding an edge between the item node associated with the respective item and the industry node associated with the respective industry associated with the respective item.

In certain aspects, generating logic 640 includes logic for generating a set of semantically similar items to the respective item. In certain aspects, generating logic 640 includes logic for, based on prompting one or more machine learning models to determine if the respective item and each semantically similar item of the set of semantically similar items are associated, generating an edge between the respective item and at least one semantically similar item of the set of semantically similar items in the knowledge graph, the edge representing a determination by the one or more machine learning models that the respective item and the at least one semantically similar item are associated. In certain aspects, generating logic 640 includes logic for generating a plurality of vector embeddings for the plurality of items and storing the plurality of vector embeddings in a vector database, wherein each respective vector embedding of the plurality of vector embeddings represents a respective item of the plurality of items in a vector space. In certain aspects, generating logic 640 includes logic for, based on prompting the one or more machine learning models to determine if the respective item and each semantically similar item of the set of semantically similar items are a same item, generating the edge, the edge representing the determination by the one or more machine learning models that the respective item and the at least one semantically similar item are the same item. In certain aspects, generating logic 640 includes logic for, based on prompting the one or more machine learning models to determine if each semantically similar item of the set of semantically similar items is a specie of a genus of the respective item, generating the edge, the edge representing the determination by the one or more machine learning models that the at least one semantically similar item is a specie of the respective item. In certain aspects, generating logic 640 includes logic for based on prompting the one or more machine learning models to determine if the respective item and each semantically similar item of the set of semantically similar items are related items, generating the edge, the edge representing the determination by the one or more machine learning models that the respective item is related to the at least one semantically similar item. In certain aspects, generating logic 640 includes logic for, for each respective item in the set of items: based on prompting the one or more machine learning models to determine if the respective item associated with a first industry of the set of industries is a same item as another item sold associated with a second industry of the set of industries, generating an edge in the knowledge graph between the respective item and the other item if no edge exists between the respective item and the other item, the edge representing the determination by the one or more machine learning models that the respective item associated with the first industry and the other item associated with the second industry are the same item.

In certain aspects, prompting logic 642 includes logic for prompting the one or more machine learning models to generate a respective first response indicating whether the respective item is a duplicate of the respective semantically similar item. In certain aspects, prompting logic 642 includes logic for prompting the one or more machine learning models to generate a respective second response indicating whether the respective semantically similar item is a duplicate of the respective item. In certain aspects, prompting logic 642 includes logic for prompting the one or more machine learning models comprises prompting a plurality of machine learning models to each generate a respective response indicating whether the respective item and each semantically similar item of the set of semantically similar items are associated. In certain aspects, prompting logic 642 includes logic for prompting the one or more machine learning models comprises prompting a single machine learning model with a plurality similar prompts to generate a respective response to each of the respective similar prompts. In certain aspects, prompting logic 642 includes logic for prompting the one or more machine learning models to determine if the respective item is a product or a service.

In certain aspects, creating logic 644 includes logic for creating a knowledge graph.

In certain aspects, querying logic 646 includes logic for querying the vector database to generate the set of semantically similar items to the respective item.

In certain aspects, providing logic 648 includes logic for providing one or more recommendations based on the knowledge graph.

In certain aspects, identifying logic 650 includes logic for identifying a set of items of the plurality of items that textually represent a same item, the set of items being associated with a set of industries of the plurality of industries.

Note that FIG. 6 is just one example of a processing system consistent with aspects described herein, and other processing systems having additional, alternative, or fewer components are possible consistent with this disclosure.

### Example Processing System for Providing Recommendations Using a Knowledge Graph

FIG. 7 depicts an example processing system 700 configured to perform various aspects described herein, including, for example, method 500 as described above with respect to FIG. 5.

Processing system 700 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 700 includes one or more processors 702, one or more input/output devices 704, one or more display devices 706, one or more network interfaces 708 through which processing system 700 is connected to one or more networks (e.g., a local network, an intranet, the Internet, or any other group of processing systems communicatively connected to each other), and computer-readable medium 712. In the depicted example, the aforementioned components are coupled by a bus 710, which may generally be configured for data exchange amongst the components. Bus 710 may be representative of multiple buses, while only one is depicted for simplicity.

Processor(s) 702 are generally configured to retrieve and execute instructions stored in one or more memories, including local memories like computer-readable medium 712, as well as remote memories and data stores. Similarly, processor(s) 702 are configured to store application data residing in local memories like the computer-readable medium 712, as well as remote memories and data stores. More generally, bus 710 is configured to transmit programming instructions and application data among the processor(s) 702, display device(s) 706, network interface(s) 708, and/or computer-readable medium 712. In certain embodiments, processor(s) 702 are representative of a one or more CPUs, GPUs, TPUs, accelerators, and/or other processing devices.

Input/output device(s) 704 may include any device, mechanism, system, interactive display, and/or various other hardware and software components for communicating information between processing system 700 and a user of processing system 700. For example, input/output device(s) 704 may include input hardware, such as a keyboard, touch screen, button, microphone, speaker, and/or other device for receiving inputs from the user and sending outputs to the user.

Display device(s) 706 may generally include any sort of device configured to display data, information, graphics, user interface elements, and the like to a user. For example, display device(s) 606 may include internal and external displays such as an internal display of a tablet computer or an external display for a server computer or a projector. Display device(s) 706 may further include displays for devices, such as augmented, virtual, and/or extended reality devices. In various embodiments, display device(s) 706 may be configured to display a graphical user interface.

Network interface(s) 708 provide processing system 700 with access to external networks and thereby to external processing systems. Network interface(s) 708 can generally be any hardware and/or software capable of transmitting and/or receiving data via a wired or wireless network connection. Accordingly, network interface(s) 708 can include a communication transceiver for sending and/or receiving any wired and/or wireless communication.

Computer-readable medium 712 may be a volatile memory, such as a random access memory (RAM), or a nonvolatile memory, such as nonvolatile random access memory (NVRAM), or the like. In this example, computer-readable medium 712 includes recommendation(s) 714, knowledge graph(s) 716, obtaining logic 718, creating logic 720, querying logic 722, and providing logic 724.

In certain aspects, obtaining logic 718 includes logic for obtaining a plurality of items used to create a knowledge graph.

In certain aspects, creating logic 720 includes logic for creating the knowledge graph.

In certain aspects, querying logic 722 includes logic for querying a knowledge graph to generate the one or more recommendations.

In certain aspects, providing logic 724 includes logic for providing the one or more recommendations.

Note that FIG. 7 is just one example of a processing system consistent with aspects described herein, and other processing systems having additional, alternative, or fewer components are possible consistent with this disclosure.

### Example Clauses

Implementation examples are described in the following numbered clauses:

Clause 1: A method of creating a knowledge graph, comprising: for each respective item, of a plurality of items, associated with a respective industry of one or more industries: adding an item node in the knowledge graph for the respective item; adding an industry node in the knowledge graph for the respective industry associated with the respective item if no industry node for the respective industry exists in the knowledge graph; generating a set of semantically similar items to the respective item; prompting one or more machine learning models to determine that the respective item and at least one semantically similar item of the set of semantically similar items are associated; and generating an edge between the respective item and the at least one semantically similar item in the knowledge graph based on the association determination.

Clause 2: The method of Clause 1, further comprising: generating a plurality of vector embeddings for the plurality of items and storing the plurality of vector embeddings in a vector database, wherein each respective vector embedding of the plurality of vector embeddings represents a respective item of the plurality of items in a vector space; and querying the vector database to generate the set of semantically similar items to the respective item.

Clause 3: The method of any one of Clauses 1-2, wherein each respective item associated with the respective industry comprises a unique item-industry pair.

Clause 4: The method of any one of Clauses 1-3, wherein wherein prompting the one or more machine learning models comprises prompting the one or more machine learning models to determine that the respective item and the at least one semantically similar item are a same item.

Clause 5: The method of Clause 4, wherein prompting the one or more machine learning models to determine that the respective item and the at least one semantically similar item are the same item comprises: prompting the one or more machine learning models to generate a respective first response indicating that the respective item is a duplicate of the at least one semantically similar item; and prompting the one or more machine learning models to generate a respective second response indicating that the at least one semantically similar item is a duplicate of the respective item.

Clause 6: The method of any one of Clauses 1-5, wherein prompting the one or more machine learning models comprises prompting the one or more machine learning models to determine that the at least one semantically similar item is a specie of a genus of the respective item.

Clause 7: The method of any one of Clauses 1-6, wherein prompting the one or more machine learning models comprises prompting the one or more machine learning models to determine that the respective item and the at least one semantically similar item are associated comprises prompting the one or more machine learning models to determine that the respective item is related to the at least one semantically similar item.

Clause 8: The method of any one of Clauses 1-7, wherein: prompting the one or more machine learning models comprises prompting a plurality of machine learning models to each generate a respective response indicating that the respective item and the at least one semantically similar item of the set of semantically similar items are associated, and the determination by the one or more machine learning models is based on the respective response generated by each respective machine learning model of the plurality of machine learning models.

Clause 9: The method of any one of Clauses 1-8, wherein the one or more machine learning models comprise one or more large language models (LLMs).

Clause 10: The method of any one of Clauses 1-9, wherein: prompting the one or more machine learning models comprises prompting a single machine learning model with a plurality similar prompts to generate a respective response to each of the respective similar prompts, and the determination by the one or more machine learning models is based on the respective response generated for each respective similar prompt of the plurality of similar prompts.

Clause 11: The method of any one of Clauses 1-10, further comprising prompting the one or more machine learning models to determine if the respective item is a product or a service.

Clause 12: The method of any one of Clauses 1-11, further comprising: for each respective item of the plurality of items, adding an edge between the item node associated with the respective item and the industry node associated with the respective industry associated with the respective item.

Clause 13: The method of any one of Clauses 1-12, wherein: the one or more industries comprise a plurality of industries; and the method further comprises: identifying a set of items of the plurality of items that textually represent a same item, the set of items being associated with a set of industries of the plurality of industries; and prompting one or more machine learning models to determine that at least one respective item, in the set of items, that is associated with a first industry of the set of industries is a same item as another item sold associated with a second industry of the set of industries; and generating an edge in the knowledge graph between the at least one respective item and the other item if no edge exists between the at least one respective item and the other item based on the determination that the at least one respective item is the same item as the other item.

Clause 14: The method of any one of Clauses 1-13, further comprising: providing one or more recommendations based on the knowledge graph, the one or more recommendations comprising an indication of at least one of: one or more businesses that sell an item of the plurality of items included in the knowledge graph; or one or more items of the plurality of items generally sold and associated with an industry of the one or more industries.

Clause 15: The method of any one of Clauses 1-14, wherein: a first industry of the one or more industries comprises a food and beverage industry, and a set of items of the plurality of items associated with the food and beverage industry comprise one or more of: a beverage; a drink; a liquid refreshment; a soft drink; a pop; a Diet Coke®; a Diet Coca-Cola®; a lemonade; a pink lemonade; a gift card; a catering service; room service; or a cleaning service.

Clause 16: A method of providing one or more recommendations comprising: querying a knowledge graph to generate the one or more recommendations, wherein the knowledge graph comprises: a plurality of item nodes associated with a plurality of items, wherein: each respective item, of the plurality of items, are associated with a respective industry of one or more industries and each respective item associated with the respective industry comprises a unique item-industry pair; one or more industry nodes associated with the one or more industries; and a plurality of edges, wherein: each respective edge of the plurality of edges connects a respective pair of items nodes of the plurality of item nodes, and each respective edge indicating that the respective items associated with the respective pair of item nodes comprise: associated items in a same industry of the one or more industries that are associated, or associated items in different industries of the one or more industries; and providing the one or more recommendations.

Clause 17: The method of Claim 16, wherein the one or more recommendations comprise an indication of one or more businesses that sell an item of the plurality of items included in the knowledge graph.

Clause 18: The method of any one of Clauses 16-17, wherein the one or more recommendations comprise an indication of one or more items of the plurality of items generally sold and associated with an industry of the one or more industries.

Clause 19: The method of any one of Clauses 16-18, wherein each respective edge indicating that the items of the respective pair of item nodes comprise the associated items in the same industry comprises an edge indicating that the respective items associated with the respective pair of item nodes comprise: a same item; a specie of a genus associated with the respective items; or related items.

Clause 20: The method of any one of Clauses 16-19, wherein each respective item of the plurality of items comprises a product or a service.

Clause 21: The method of any one of Clauses 16-20, further comprising creating the knowledge graph.

Clause 22: The method of any one of Clauses 16-21, wherein: a first industry of the one or more industries comprises a food and beverage industry, and a set of items of the plurality of items associated with the food and beverage industry comprise one or more of: a beverage; a drink; a liquid refreshment; a soft drink; a pop; a Diet Coke®; a Diet Coca-Cola®; a lemonade; a pink lemonade; a gift card; a catering service; room service; or a cleaning service.

Clause 23: A processing system, comprising: a memory comprising computer-executable instructions; and a processor configured to execute the computer-executable instructions and cause the processing system to perform a method in accordance with any one of Clauses 1-22.

Clause 24: A processing system, comprising means for performing a method in accordance with any one of Clauses 1-22.

Clause 25: A non-transitory computer-readable medium storing program code for causing a processing system to perform the steps of any one of Clauses 1-22.

Clause 26: A computer program product embodied on a computer-readable storage medium comprising code for performing a method in accordance with any one of Clauses 1-22.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for. ” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of creating a knowledge graph, comprising:
for each respective item, of a plurality of items, associated with a respective industry of one or more industries:
adding an item node in the knowledge graph for the respective item;
adding an industry node in the knowledge graph for the respective industry associated with the respective item if no industry node for the respective industry exists in the knowledge graph;
generating a set of semantically similar items to the respective item;
prompting one or more machine learning models to determine that the respective item and at least one semantically similar item of the set of semantically similar items are associated; and
generating an edge between the respective item and the at least one semantically similar item in the knowledge graph based on the association determination.

2. The method of claim 1, further comprising:
generating a plurality of vector embeddings for the plurality of items and storing the plurality of vector embeddings in a vector database, wherein each respective vector embedding of the plurality of vector embeddings represents a respective item of the plurality of items in a vector space; and
querying the vector database to generate the set of semantically similar items to the respective item.

3. The method of claim 1, wherein each respective item associated with the respective industry comprises a unique item-industry pair.

4. The method of claim 1, wherein prompting the one or more machine learning models comprises prompting the one or more machine learning models to determine that the respective item and the at least one semantically similar item are a same item.

5. The method of claim 4, wherein prompting the one or more machine learning models to determine that the respective item and the at least one semantically similar item are the same item comprises:
prompting the one or more machine learning models to generate a respective first response indicating that the respective item is a duplicate of the at least one semantically similar item; and
prompting the one or more machine learning models to generate a respective second response indicating that the at least one semantically similar item is a duplicate of the respective item.

6. The method of claim 1, wherein prompting the one or more machine learning models comprises prompting the one or more machine learning models to determine that the respective item and the at least one semantically similar item are associated comprises prompting the one or more machine learning models to determine that the at least one semantically similar item is a specie of a genus of the respective item.

7. The method of claim 1, wherein prompting the one or more machine learning models comprises prompting the one or more machine learning models to determine that the respective item and the at least one semantically similar item are associated comprises prompting the one or more machine learning models to determine that the respective item is related to the at least one semantically similar item.

8. The method of claim 1, wherein:
prompting the one or more machine learning models comprises prompting a plurality of machine learning models to each generate a respective response indicating that the respective item and the at least one semantically similar item of the set of semantically similar items are associated, and
the association determination by the one or more machine learning models is based on the respective response generated by each respective machine learning model of the plurality of machine learning models.

9. The method of claim 1, wherein:
prompting the one or more machine learning models comprises prompting a single machine learning model with a plurality similar prompts to generate a respective response to each of the respective similar prompts, and
the association determination by the one or more machine learning models is based on the respective response generated for each respective similar prompt of the plurality of similar prompts.

10. The method of claim 1, further comprising prompting the one or more machine learning models to determine if the respective item is a product or a service.

11. The method of claim 1, further comprising:
for each respective item of the plurality of items, adding an edge between the item node associated with the respective item and the industry node associated with the respective industry associated with the respective item.

12. The method of claim 1, wherein:
the one or more industries comprise a plurality of industries; and
the method further comprises:
identifying a set of items of the plurality of items that textually represent a same item, the set of items being associated with a set of industries of the plurality of industries; and
prompting one or more machine learning models to determine that at least one respective item, in the set of items, that is associated with a first industry of the set of industries is a same item as another item sold associated with a second industry of the set of industries; and
generating an edge in the knowledge graph between the at least one respective item and the other item if no edge exists between the at least one respective item and the other item based on the determination that the at least one respective item is the same item as the other item.

13. The method of claim 1, further comprising:
providing one or more recommendations based on the knowledge graph, the one or more recommendations comprising an indication of at least one of:
one or more businesses that sell an item of the plurality of items included in the knowledge graph; or
one or more items of the plurality of items generally sold and associated with an industry of the one or more industries.

14. A method of providing one or more recommendations comprising:
querying a knowledge graph to generate the one or more recommendations, wherein the knowledge graph comprises:
a plurality of item nodes associated with a plurality of items, wherein:
each respective item, of the plurality of items, are associated with a respective industry of one or more industries; and
each respective item associated with the respective industry comprises a unique item-industry pair;
one or more industry nodes associated with the one or more industries; and
a plurality of edges, wherein:
each respective edge of the plurality of edges connects a respective pair of items nodes of the plurality of item nodes, and
each respective edge indicating that the respective items associated with the respective pair of item nodes comprise:
associated items in a same industry of the one or more industries that are associated, or
associated items in different industries of the one or more industries; and
providing the one or more recommendations.

15. The method of claim 14, wherein the one or more recommendations comprise an indication of one or more businesses that sell an item of the plurality of items included in the knowledge graph.

16. The method of claim 14, wherein the one or more recommendations comprise an indication of one or more items of the plurality of items generally sold and associated with an industry of the one or more industries.

17. The method of claim 14, wherein each respective edge indicating that the items of the respective pair of item nodes comprise the associated items in the same industry comprises an edge indicating that the respective items associated with the respective pair of item nodes comprise:
a same item;
a specie of a genus associated with the respective items; or
related items.

18. The method of claim 14, wherein each respective item of the plurality of items comprises a product or a service.

19. The method of claim 14, further comprising creating the knowledge graph.

20. A processing system, comprising:
a memory comprising computer-executable instructions; and
a processor configured to execute the computer-executable instructions and cause the processing system to:
for each respective item, of a plurality of items, associated with a respective industry of one or more industries:
add an item node in a knowledge graph for the respective item;
add an industry node in the knowledge graph for the respective industry associated with the respective item if no industry node for the respective industry exists in the knowledge graph;
generate a set of semantically similar items to the respective item; and
prompt one or more machine learning models to determine that the respective item and at least one semantically similar item of the set of semantically similar items are associated; and
generate an edge between the respective item and the at least one semantically similar item based on the association determination.
